(19) United States
(12) Patent Application Publication
(10) Pub. No.: US 2005/0033732 A1
(43) Pub. Date: Feb. 10, 2005

(54) Search engine having navigation path and orphan file features

(76) Inventors: Ching-Chung Chang, Hsinchu City (TW); Frank Sung, Hsinchu (TW); Cheng-hui Chiu, Hsinchu City (TW)

Correspondence Address: DUANE MORRIS, LLP;IP DEPARTMENT, ONE LIBERTY PLACE, PHILADELPHIA, PA, 19103-7396, US

(21) Appl. No.: 10/636,936

(22) Filed: Aug. 6, 2003

(51) Int. Cl. G06F 17/30

(52) U.S. Cl. 707/2

(57) ABSTRACT

A search engine (100) has a top down transversal algorithm (112) that distinguishes active objects of a website from orphan files depicted in graphs of HTML files of a graph database of the objects and their HTML relations. A collection building utility (120) assembles a batch collection of solely the active objects for retrieval by a search query, which prevents retrieval of an orphan file that would provide a website visitor with incorrect information.

### REFERENCE TO A COMPUTER PROGRAM LISTING

A computer program listing, submitted at the end of the specification herein, implements a function: f_GetStaticNavPath.

### FIELD OF THE INVENTION

The present invention relates to a search engine for assembling a batch collection of objects or nodes corresponding to URL objects of a website, and more particularly, to a search engine that prevents a search query from retrieving inactive objects or nodes.

### BACKGROUND

A search engine enables a website visitor to search for an object or node of the website by using a search query, such as, a key word. The visitor inputs the search query at an appropriate location on the website, using the visitor's web browser on a work station computer. In response the search engine retrieves the object or node matching the query from a batch collection, and displays the object or node on a display device of the computer. The retrieved object or node is the equivalent of an object of the website having a URL, uniform resource locator, an address location for the object on the Internet.

The terminology, “object” refers to a valid active object of the website that is retrieved by using a search path provided by the website, for example, by executing a series of computer commands, such as, mouse clicks, on a series of hyperlinks that navigate to successive web pages, until reaching the object. Further, the terminology, “object” refers to an object that is in a batch collection assembled by a search engine. The terminology, “object” is interchangeable with the terminology “node.” Further, the terminology “node” connotes a Hypertext Markup Language node, HTML node, i.e. object, in a hierarchical navigation path of HTML relations, as well as an object at a hierarchical end of a navigation path, i.e. a leaf node. The leaf node can be an HTML object, or other formatted file, such as, *.PDF, *.DOC, *.PPT, . . . (*.*). The terminology, “navigation path,” refers to all HTML hierarchical relations, or links, connecting a node along the navigation path.

A search engine has a web crawler that searches through the web directories of a URL website and organizes the objects or nodes as data files in a database. The search engine assembles the database files into a batch collection. The search engine makes the batch collection searchable by search queries. The advantage is that a visitor to the website can quickly retrieve a desired object by using a search query, which saves the visitor from the task of having to conduct a trial and error search on the website itself to find the object.

Prior to the invention, a search engine assembled a batch collection of objects without including their navigation paths, or links. An object that was retrieved from the batch collection was displayed on the visitor's computer display without a navigation path that the visitor could follow to verify the object as an active object of a website. Thus, a retrieved object that was an inactive object could display obsolete or otherwise incorrect information.

A valid active object is one that is included together with a starting node in a navigation path. A starting node is reachable by beginning with the home page. An inactive object is not reachable by conducting a search from the home page. Prior to the invention, a batch collection would contain an inactive object even when the equivalent inactive object was not retrievable by searching the website from the home page. Thus, a batch collection may have been assembled with one or more inactive objects, which are orphan files.

A search engine must be able to prevent retrieval of an orphan file that would provide a visitor with incorrect information. For example, an orphan file could show obsolete information or erroneous information pertaining to a product, or to a manufacturing drawing or to a manufacturing process, which the visitor would detrimentally rely upon.

Prior to the invention, a batch collection assembled by a search engine did not have the capability of identifying orphan files. Thus, an orphan file was capable of being retrieved from a batch collection assembled by a search engine, which could have provided a visitor with incorrect information. Further, orphan files could not be singled out as candidates for deletion from the data base.

U.S. Pat. No. 6,144,962 discloses a graph data base having files of URLs or objects, as nodes, and their links or navigation paths. The database files build node tree graphs, comprised of the nodes and their links or navigation paths that connect the nodes in a hierarchy. The graphs are mapped and are subjected to URL filtering features to find common website problems, such as links in need of repair and missing URLs.

FIG. 3A is a flow diagram of a process performed by the search engine disclosed by FIG. 1.

FIG. 3B is a flow diagram of another embodiment of a process performed by the search engine disclosed by FIG. 1.

### DETAILED DESCRIPTION

FIG. 1 discloses apparatus (100) in the form of a search engine A web crawler (102) is a utility software program according to the invention that searches, by scanning and parsing, all HTML files that are stored in website file directories (104) and (106). The web crawler (102) retrieves all HTML cross hierarchical relations between objects, i.e., HTML nodes, and organizes them in a graph database (108). The web crawler (102) builds the graph database (108) of HTML objects, equivalent to the objects of the website, and their HTML navigation paths. The navigation paths are expressed as structural data elements depicting the HTML cross hierarchical relations among the objects of the website.

The web crawler (100) searches according to the following process.
1. Search the web directory of HTMLs Hyperlink information and Referenced Node Title from character string “, A . . . HREF=“Hyperlink information”>Referenced Node Title</A”.
2. Translate the relative path of Hyperlink information and Referenced Node Title into an absolute one, i.e., a single path name. For Example, translate “../../online/index.htm” in “/html/ECx/intro_promo/a.htm” into “/online/index.htm”.
3. Handle the file in name with space characters which are changed to %20 in URL.
4. Build graphs of the HTML hierarchical relations between each HTML parent object node and each HTML referenced, HTML child object node. The web crawler (100) builds the hierarchical relations as structural data depictions that extend between a parent node and each child object node. Thereby, the web crawler (102) defines the start HTML nodes that are the obvious starting nodes in the root home page of the website.

FIG. 2 discloses examples of graphs (200) built by the web crawler (102). The graphs (200) appear as a network of structural data elements. The web crawler (100) builds the structural data elements to depict the HTML hierarchical relations among the HTML nodes. In

### SUMMARY OF THE INVENTION

The present invention relates to a method of assembling a collection of retrievable objects of a website, by distinguishing active objects of the website from orphan files depicted in graphs of graph database files having the objects and their HTML relations; and by assembling solely the active objects of the website in a batch collection for retrieval by a search query.

According to an embodiment of the invention, the invention method implements a recursive function on graphs built by a graph database, and discovers the object hierarchy in a website, and distinguishes active objects from inactive objects of the website.

According to a further embodiment of the invention, the method further builds the shortest navigation path of each of the active objects to a home page of the website, wherein the shortest navigation path excludes intervening nodes between the active objects and the home page.

According to a further embodiment of the invention the method further associates the shortest navigation path, as described above, with easy to understand information for retrieval together with a corresponding object matching a search query. The navigation path is easily understood and followed, which verifies that an object is in a navigation path with the home page.

The present invention further relates to a search engine that builds a graphical database of all HTML files and their HTML hierarchical relations, and that builds a graphical database collection of all nodes and their HTML hierarchical relations from the start node root categories in the web site, and that builds a collection of all HTML hierarchical relations in a graphical database.

Embodiments of the invention will now be described by way of example with reference to the accompanying drawings.

### BRIEF DESCRIPTION OF THE DRAWINGS

FIG. 1 is a schematic view of apparatus in the form of a search engine.

FIG. 2 is a graph of structural elements depicting HTML hierarchical relations and of a web site directory, the graph including each HTML parent node and each HTML child node.

FIG. 2, the nodes are labeled, pseudo root node (202), S11, N22, L32, L31, O21, O11, S12, N24, L34, N23, L33. Such nodes are data elements organized in the graph database (108). All the HTML hierarchical relations are entered in the graph database as graphs cross referenced to the HTML nodes as data elements. The website can have leaf nodes, which are nodes at the end of navigation paths. The leaf nodes can be HTML file nodes, or some other formatted files, such as, *.PDF, *.DOC, *.PPT, . . . (*.*). All of the leaf nodes are data elements in files of the graph database (108), and are cross referenced to their graphs. The web crawler (102) enters the graphs and data elements in a storage device (110), labeled, objects cross referenced to graphs, for storage and retrieval.

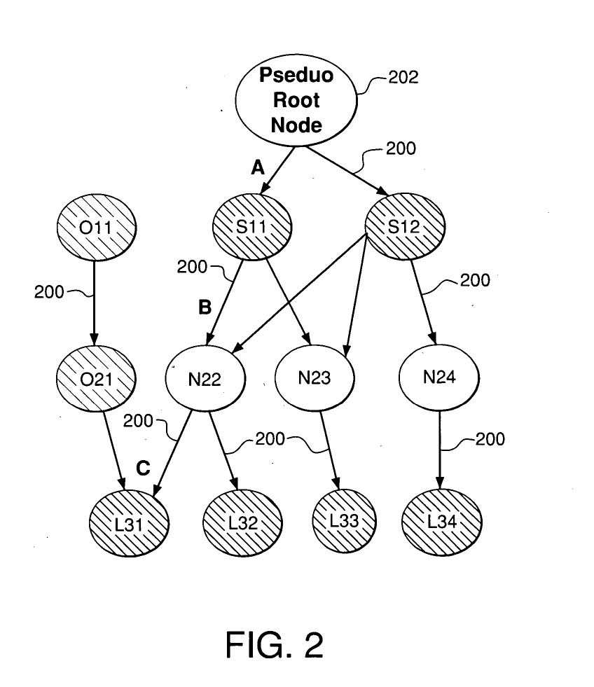

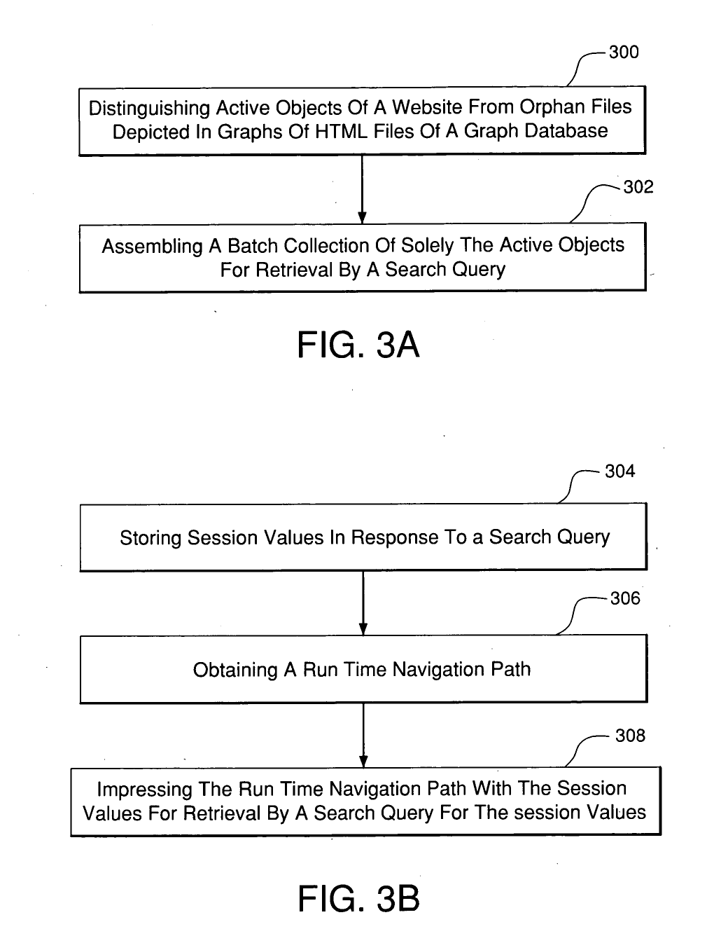

With further reference to FIG. 2. the graphs (200) disclose an exemplary pseudo root node (202) that is representative of multiple pseudo root nodes (202) of the website. The website home page is a pseudo root node (202). Further, the home page has root categories, which are entry points of navigation paths from the home page to pseudo root nodes (202) other than the home page. Thus, the pseudo root node (202), as described herein, refers to either the home page or to a root category pseudo root node (202), other than the home page.

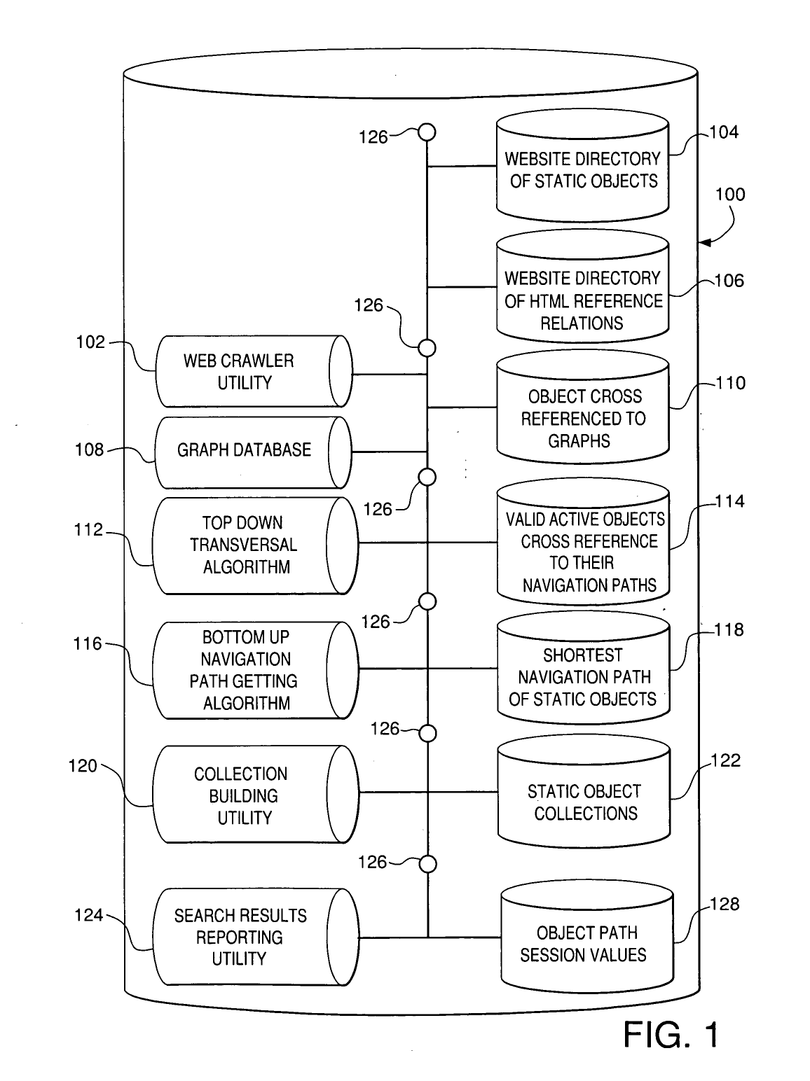

FIG. 1 further discloses a top down transversal algorithm (112) of the present invention that visits, i.e., scans and parses, the graphs created by the web crawler (102), beginning with the pseudo root nodes, and visits the child nodes of the graphs that are connected by hierarchical navigation paths with the parent nodes. The top down transversal process starts from the pseudo root nodes (202).

With reference to FIG. 2, the top down transversal algorithm (112) implements a function: f_GetStaticNavPath, according to the computer listing at the end of the specification herein, by visiting, i.e., scanning and parsing, the pseudo root nodes (202) of the graphs, then following along the structural elements of the graphs leading to the child nodes on the graphs that are in direct succession to the parent, pseudo root nodes (202). After visiting the next nodes in succession from a parent node, the algorithm follows along structural elements of the graphs leading to the next succession of child nodes that are in direct succession to their parent nodes, and which have not yet been visited. The child node visiting order is: S11. S12. N21, N22, N23, L31, L32, L33, L34. The order of parent to child succession of the nodes in the graphs determines the visiting order, and further, determines the relative lengths of the navigation paths to the nodes. The algorithm (112) stores cross references of the nodes and their navigation paths in a storage device (114), labeled, valid active objects cross referenced to their navigation paths.

With further reference to FIG. 2, the nodes O11 and O21 are not capable of being visited, because they do not have navigation paths that include respective pseudo root nodes (202). Accordingly, the nodes O11 and O21 are orphan files. Thus, the valid active nodes are distinguished from the orphan files O11 and O21. The orphan files are readily singled out as candidates for deletion from the website, together with their HTML references, if any.

Following the operation of the top down transversal algorithm (112), a bottom up navigation path getting algorithm (116) implements the recursive function: f_GetStaticNavPath, according to the computer program listing at the end of the specification herein, by visiting, i.e., scanning and parsing, the graphs created by the web crawler (102), beginning with the child nodes in the order determined by the order of the child nodes in the graphs. The bottom up navigation path getting algorithm (116) constructs a database of the shortest navigation paths from respective child nodes to one pseudo root node (202). No navigation paths will be constructed for orphan files previously distinguished from valid active nodes. The database of the shortest navigation paths will not have orphan files. Thus, the bottom up navigation path getting algorithm (116) constructs the shortest navigation path for each node that corresponds to a valid active object of the website, which are stored in a storage device (118) labeled, shortest navigation path of objects.

With reference to FIG. 2, the bottom up navigation path getting algorithm (116) constructs the shortest navigation path for each node according to the mathematical expression:
NavPath(to Child from pseudo root node)=NavPath(from Child to One Parent with Navigation Path to pseudo node)+Link (from Parent to Child).

For example:
NavPath(S11)=A
NavPath(N22)=NavPath(S11)+B=A+B=AB
NavPath(L31)=NavPath(N22)+C=AB+C=ABC

The bottom up navigation path getting algorithm (116) stores, the data for the shortest navigation path of objects to a pseudo node, in a storage device (118). For example, the data include:

Node S11 with its shortest navigation path A to a pseudo node,

Node N22 with its shortest navigation path AB to a pseudo node,

Node L31 with its shortest navigation path ABC to a pseudo node.

An advantage is that the shortest navigation path of each node to a pseudo root node (202) is defined without including intervening nodes. Further, with respect to those objects that have navigation paths originating from root category starting nodes, i.e., pseudo root nodes (202), the database includes information that indicates the objects are active objects of the website. Easy to understand information is generated to describe each of the shortest navigation paths. The easy to understand information is suggestive of corresponding objects represented by the nodes.

Further, for example, the easy to understand information comprises information labels that are identical to the hyperlink labels displayed by the website. The hyperlink labels identify the hyperlinks for receiving click-on commands to retrieve the objects. Further the hyperlink labels are easily understood, and are suggestive of corresponding objects to be retrieved. Further, the hyperlink labels are HTML files in one of the web directories (104) and (106). The bottom up navigation path getting algorithm (116) retrieves the HTML hyperlink labels, i.e. the easy to understand information, and cross references them to the HTML nodes. The data is stored by the bottom up navigation path getting algorithm (116) in a storage device (118).

A collection building utility (120) of the search engine (100) retrieves objects and retrieves the shortest navigation paths from the storage device (118). The collection building utility (120) assembles object collections, together with their shortest navigation paths, and stores them in a storage device (122). The object collections excludes orphan files, which exclude each object that has obsolete or otherwise incorrect information.

A search results reporting utility (124) generates a report of search results of one or more objects that match a search query submitted by a visitor to the website. Further, each object is reported together with its shortest navigation path, as determined by the combined operations of the top down transversal algorithm (112) and the bottom up navigation path getting algorithm (116).

Further, the search results reporting utility (124) reports the shortest navigation path as having easy to understand information. Further, the search results reporting utility (124) reports the shortest navigation path as an HTML navigation path without intervening HTML objects in the navigation path. Thus, a navigation path reported on the report is a direct navigation path to the home page pseudo root node (202). By performing a single, mouse click, command on the shortest navigation path, the equivalent object of the website will be displayed on the visitor's computer display device. Thereby, the navigation path is easily followed to verify that the object included with the navigation path is a valid active object of the home page.

FIG. 1 discloses the search engine (100) with system connections (126). When the search engine (100) is in an integrated system architecture within an application server of the website, the system connections (126) are connected in series, as depicted by FIG. 1, within the application server. Alternatively, each of the system connections (126) is capable of connection to a known router, not shown, whereby the search engine (100) is in a distributed system architecture.

FIG. 3A discloses an embodiment of a method according to the invention. The top down transversal algorithm (112) performs a method step (300) of, distinguishing active objects of the website from orphan files depicted in graphs of HTML files of a graph database of the objects and their HTML relations. The collection building utility (120) performs a method step (302) of, assembling a batch collection of solely the active objects for retrieval by a search query.

With further reference to FIG. 1, session values, that record the visit of each visitor, after log-in to the website, are saved in a storage device (128), labeled, object path session values. When the visitor submits a query for the session values, the search results reporting utility (124) retrieves the previous session values, and signals the top down transversal algorithm (112) and the bottom up navigation path getting algorithm (116), to implement a run-time recursive function: f_GetStaticNavPath, according to the computer program listing at the end of the specification herein, to get a run-time navigation path. The search engine (100) imbeds the session values in the run time navigation path. The session values are then matched to the visitor's query for the same, and include a working valid navigation path for an object that matches the session values.

FIG. 3B discloses an embodiment of a method according to the invention. The search reporting utility (124) and the object path session values storage device (128) perform a method step (304) of, storing session values in response to a search query. Further, the search results reporting utility (124) performs a method step (306) of, obtaining a run time navigation path. Further, the search results reporting utility (124) performs a method step (308) of, impressing the run time navigation path with the session values for retrieval by a search query for the session values.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

COMPUTER PROGRAM LISTING

*****************************************************************

' Top Down From Parent Category

```
' *****************************************************************
Sub BrowseFromParent(ByVal LevelNo As Long, DosParentPath As String, MapUnixPath As
String)
  Dim FileName As String, CurFileDate As Date, CurPath As String
  Dim strMessage As String, nProcessing As Long, strFileDate As String
  Dim DirArray(100) As String, MapArray(100) As String, nDirCurr As Integer, i As Long
  Dim FileToProc As String, UnixFileToProc As String, filetype As String
  nProcessing = 0
  nDirCurr = 0
  CurPath = DosParentPath + “\”
  FileName = Dir(CurPath, vbDirectory)
  Retcode = ProcessMessage(“***************************************************”,
16, “”, MessageType)
  Retcode = ProcessMessage(“Browse ” + CurPath, 16, “”, MessageType)
  Do While FileName <> “”
    If FileName <> “..” And FileName <> “.” Then
      X% = DoEvents( )
      FileToProc = CurPath + FileName
      UnixFileToProc = MapUnixPath + “/” + FileName
      CurFileDate = FileDateTime(FileToProc)
      nProcessing = nProcessing + 1
'  Attach
      If (GetAttr(CurPath + FileName) And vbDirectory) = vbDirectory Then
        DirArray(nDirCurr) = FileToProc
        MapArray(nDirCurr) = UnixFileToProc
        Retcode = ProcessMessage(“i.D [“ + FileToProc + ”]−” + “[“ + UnixFileToProc + ”]”, 16,
“”, MessageType)
        nDirCurr = nDirCurr + 1
        ' Call BrowseFromRoot(CurPath + FileName)
      Else
' File
        filetype = GetFileType(FileName)
        strFileDate = Format(FileDateTime(CurPath + FileName), “MM/DD/YYYY”)
        If f_StaticFileToBuild(filetype) = 1 Then
        Call InsertPageDef(LevelNo, UnixFileToProc, “”, strFileDate)
        ' Hit our HTML pages
          If filetype = “HTML” Or filetype = “HTM” Then
            Retcode = ProcessMessage(“$$H [“ + FileToProc + ”]”, 16, “”, MessageType)
'If InStr(1, UnixFileToProc, “cancel_reservation”, vbTextCompare) > 0 Then
            Call HTMLParser(LevelNo, FileToProc, UnixFileToProc, MapUnixPath)
' End If
          Else
            Retcode = ProcessMessage(“$$³F [“ + FileToProc + ”]”, 16, “”, MessageType)
          End If
        End If
      End If ' it represents a directory
    End If
    ' FileName = Dir(CheckPath, vbNormal) ' Get one more file name!
    FileName = Dir ' Get one more file name!
  Loop
  For i = 0 To nDirCurr − 1
    Call BrowseFromParent(LevelNo + 1, DirArray(i), MapArray(i))
  Next i
End Sub
' *****************************************************************
'  HTML Parser to extract the hierarchical relations
' *****************************************************************
Sub HTMLParser(ByVal LevelNo As Long, FileToParse As String, UnixFileToParse As String,
UnixParentFolder As String)
  Dim FileNumber As Integer, TextLine, HrefToken As String
  Dim HrefPos As Long, equalPos As Long, preQuotePos As Long, postQuotePos As Long
  Dim Sind As Long, CurPos As Long, EndATagPos As Long, GrSignPos As Long
  Dim spacePos As Long, LenText As Integer, AnchorPos As Long
  Dim ReferURLPath As String, ReferTitle As String, CH As String
  Dim ToSave As Integer, PrevExec As String, i As Integer
  FileNumber = FreeFile
'
  Open FileToParse For Input As FileNumber
  Do While Not EOF(FileNumber) ' Loop until end of file.
    Line Input #FileNumber, TextLine ' Read line into variable.
    TextLine = Trim(TextLine)
Loop_Start:
    AnchorPos = InStr(1, TextLine, “<A”, vbTextCompare)
    If AnchorPos > 0 Then '
      Sind = AnchorPos + 2
      Call LocateToken(TextLine, “HREF”, FileNumber, Sind, HrefPos, “>”)
      If HrefPos > 0 Then '
        Retcode = ProcessMessage(“=================================”, 16, “”,
MessageType)
''''''''''' Fetch the tokens we want
        equalPos = InStr(HrefPos + 1, TextLine, “=”, vbTextCompare)
        If equalPos > 0 Then ' = after HREF
          preQuotePos = InStr(equalPos + 1, TextLine, “”“”, vbTextCompare)
          If preQuotePos > 0 Then ' has “
' PostQuotePos = InStr(PreQuotePos + 1, TextLine, “”“”, vbTextCompare)
            Call LocateToken(TextLine, “”“”, FileNumber, preQuotePos + 1, postQuotePos, “>”)
              HrefToken = Trim(Mid$(TextLine, preQuotePos + 1, postQuotePos − preQuotePos −
1))
              CurPos = spacePos + 1
            Else '
              LenText = Len(TextLine)
              Sind = equalPos + 1
              Do
                If Mid$(TextLine, Sind, 1) <> “ ” Then
                  Exit Do
                ElseIf Sind >= LenText Then
                  Sind = 0
                  Exit Do
                Else
                    Sind = Sind + 1
                End If
              Loop
              spacePos = Len(TextLine)
              For i = Sind To spacePos
                CH = Mid$(TextLine, i, 1)
                If CH = “ ” Or CH = “>” Then
                  spacePos = i
                  Exit For
                End If
              Next i
              HrefToken = Trim(Mid$(TextLine, equalPos + 1, spacePos − equalPos − 1))
              CurPos = spacePos + 1
            End If
' If InStr(1, TextLine, “cancel_reservation”, vbTextCompare) > 0 Then
' CurPos = CurPos
' End If
' find > corresponding to <A
            Call LocateToken(TextLine, “>”, FileNumber, equalPos + 1, GrSignPos, “<”)
            CurPos = GrSignPos + 1
' Find </A>
            Call LocateToken(TextLine, “/A>”, FileNumber, CurPos, EndATagPos, “<A”, “/T”)
' Between <A ...> and </A> is Title of this URL
            If EndATagPos > 0 Then
              ReferTitle = Trim(Mid$(TextLine, GrSignPos + 1, EndATagPos − GrSignPos − 2))
              Retcode = ProcessMessage(“O_URL=” + HrefToken, 16, “”, MessageType)
              ReferURLPath = Trim(GetRealURL(HrefToken, UnixParentFolder, PrevExec))
              Retcode = ProcessMessage(“O_Title=” + ReferTitle, 16, “”, MessageType)
              Retcode = TranslateTitle(UnixParentFolder, ReferTitle)
              If Retcode = 1 Then
                Retcode = ProcessMessage(“Title Translated=” + ReferTitle, 16, “”, MessageType)
              End If
              If ReferURLPath <> “” Then
                If InStr(1, ReferURLPath, “http”) > 0 Then
' Call InsertPageDef(gPageID, ReferURLPath)
                  Retcode = ProcessMessage(“X URL=” + ReferURLPath, 16, “”, MessageType)
                Else
' remove the session & engine part from URL
                  Call SplitArgFromURL(ReferURLPath, ToSave)
                  If ToSave = 1 Then
                    ReferURLPath = TranslatePath(UnixParentFolder, ReferURLPath)
                    If UnixFileToParse <> ReferURLPath Then
                      Retcode = ProcessMessage(“Insert Ref=” + ReferURLPath, 16, “”,
MessageType)
                      Call InsertPageRef(LevelNo, UnixFileToParse, ReferTitle, ReferURLPath,
PrevExec)
                    Else
                      Retcode = ProcessMessage(“X loop URL=” + ReferURLPath, 16, “”,
MessageType)
                    End If
                  Else
                    Reteode = ProcessMessage(“X URL=” + ReferURLPath, 16, “”, MessageType)
                  End If
                End If
              End If ' End of If ReferURLPath <> “” Then
              TextLine = Mid$(TextLine, EndATagPos + 4) ' </A>
            GoTo Loop_Start
          End If ' End of If EndATagPos > 0 Then
        End If ' End of If EqualPos > 0 Then
      End If ' End of If HrefPos > 0 Then
    End If ' End of If AnchorPos > 0 Then
  Loop
  Close FileNumber
End Sub
```

1. A method of assembling a collection of retrievable URL objects of a website, comprising the steps of:
distinguishing active objects of the website from orphan files depicted in graphs of HTML files of a graph database of the objects and their HTML relations; and
assembling solely the active objects of the website in a batch collection for retrieval by a search query.

2. The method of claim 1, and further comprising the step of: implementing a recursive function top down on the graphs, and discovering the object hierarchy in a website, which hierarchy distinguishes the active objects from orphan files.

3. The method of claim 1, and further comprising the step of: making a shortest navigation path of each active object of the website to the home page of the website, wherein the shortest navigation path is retrievable together with a corresponding object that matches the search query.

4. The method of claim 1, and further comprising the step of: making a shortest navigation path of each active object of the website to the home page of the website, by implementing a recursive function bottom up on the graphs, wherein the shortest navigation path is retrievable together with a corresponding object that matches the search query.

5. The method of claim 1, and further comprising the steps of:
making a shortest navigation path of each active object of the website to the home page of the website, and
associating the shortest navigation path with easy to understand information for retrieval together with a corresponding object that matches the search query.

6. The method of claim 1, and further comprising the steps of:
storing session values in response to the search query;
obtaining a run time navigation path of an object that matches the session values, by implementing a recursive function top down and bottom up on the graphs for said object; and
impressing the run time navigation path with the session values for retrieval in response to another search query for the session values.

7. A search engine, comprising:
a web crawler that searches a website directory and builds graphs having URL objects of the website as nodes, and hierarchial hierarchical relations between nodes as structural elements;
a top down transversal algorithm distinguishing active URL objects on the graphs from orphan files on the graphs, and
a collection building utility assembling a batch collection of solely the active URL objects for retrieval by a search query.

8. The search engine of claim 7 and further comprising: a bottom up navigation path getting algorithm building a shortest navigation path of each active object to a website home page.

9. The search engine of claim 7 and further comprising:
a bottom up navigation path getting algorithm building a shortest navigation path of each active object to a website home page; and
a search results reporting utility.
